(19) United States
(12) Patent Application Publication
(10) Pub. No.: US 2021/0197211 A1
(43) Pub. Date: Jul. 1, 2021

(54) BENEFICIATION OF PHOSPHATE FROM PHOSPHATE CONTAINING ORES

(71) Applicant: BASF SE, Ludwigshafen am Rein (DE)

(72) Inventors: Alexej Michailovski, Ludwigshafen (DE); Adrian Mauricio Villanueva Berindoague, Ludwigshafen (DE); Sylvia von Krog, Ludwigshafen (DE); Tamara Kuelzer, Ludwigshafen (DE)

(21) Appl. No.: 17/270,119

(22) PCT Filed: Aug. 29, 2019
(86) PCT No.: PCT/EP2019/073101

§ 371 Date: Feb. 22, 2021

(30) Foreign Application Priority Data
Aug. 30, 2018 (EP) 18191801.2

(51) Int. Cl. B03D 1/02; B03D 1/012; B03D 1/008; B03D 1/004

(52) U.S. Cl. CPC B03D 1/021; B03D 1/012; B03D 2203/06; B03D 1/0043; B03D 2201/02; B03D 1/008

(57) ABSTRACT

The present invention relates to a collector composition for beneficiation of phosphates from phosphate containing ores comprising at least one component A, at least one component B, and at least one component C, wherein the component A comprises unsaturated fatty acids having 12 to 22 carbon atoms, the component B comprises alkoxylated branched alcohols as non-ionic surfactant which comprise two different types of alkoxy moieties, and the component C comprises sulfur-containing surfactants. The present invention further relates to the use of said collector composition in flotation processes, and to a method for beneficiation of phosphates using said collector composition.

The present invention relates to a collector composition for beneficiation of phosphates from phosphate containing ores, their use in flotation processes and to a method for beneficiation of phosphates using said collector composition.

### BACKGROUND OF THE INVENTION

A majority of phosphate fertilizer supply is produced by processing sedimentary phosphate ores. The global depletion of easily accessible high-grade phosphate deposits leads to a rising demand of beneficiation technologies in phosphate ore processing, in order to make low-grade phosphate rock accessible as phosphate source. In principle, the phosphate containing ores are processed to achieve an apatite concentrate, which is further processed to phosphoric acid and then into fertilizers. Typically, flotation processes, either direct and/or reverse flotation processes are applied for the beneficiation of phosphate containing ores and often several flotation stages are required. The froth flotation as separation technology in principle makes use of differences in hydrophobicity between the valuable desired material and the waste gangue impurities. For phosphate ores, the type of phosphate deposit affects the flotation performance. For sedimentary deposits of phosphate ores, the desired phosphate concentration can be achieved by flotation of silicate impurities from the finely ground phosphate containing ores (reverse flotation) when the gangue impurities essentially consist of siliceous materials. For sedimentary phosphates with high carbonates, however, beneficiation of phosphate ores by separation of carbonate from phosphate presents especial difficulties since it requires a reagent selective between two chemically similar surfaces (apatite vs. calcite) (H. Sis et al., Minerals Engineering, 16 (2003) 577-585).

Both, direct apatite flotation (e.g. from igneous ores) and reverse flotation (flotation of the carbonate and/or silicate impurities contained in the phosphoric rock) typically use fatty acid based collector systems as reagents to increase the differences in hydrophobicity between the desired and undesired material. The main primary collectors are based on partly unsaturated fatty acids (C₁₂-C₁₈), which are employed at pH 4-5, with phosphoric acid as depressant. Since fatty acids are badly soluble in water at that pH, secondary collectors are used, typically anionic or nonionic surfactants, to improve selectivity and recovery.

Surfactants are amphiphilic interface-active compounds which comprise a hydrophobic molecular moiety and also a hydrophilic molecular moiety and, in addition, can have charged and uncharged groups. Surfactants are orientedly absorbed at interfaces and thereby reduce the inter-facial tension so that these can form, in solution, association colloids above the critical micelle-formation concentration, meaning that substances which are per se water-insoluble are solubilized. On account of these properties, surfactants are used, for example, for wetting such as fibers or hard surfaces. Typical files of application are detergents and cleaners for textiles and leather, as formulation of paints and coatings and also for example in the flotation process of non-sulfidic ores.

Especially in reverse flotation, the effect of a secondary collector on flotation performance is critical due to the low solubility and limited self-emulsification ability of fatty acids at low pH, which in turn is required to achieve selectivity between carbonates and phosphates (e.g. calcite and apatite). A common class of high performance flotation additives for phosphate beneficiation are alkyl phenol ethoxylates (APEOs), powerful emulsifying additives with a hazardous environmental profile whose application is restricted or banned in many jurisdictions. Other suitable secondary collectors are sulfonate compounds. With these compounds a typical P₂O₅ grade of up to 30 wt % can be achieved starting with a typical sedimentary ore containing approx. 15 to 20 wt % P₂O₅. In particular, in the fertilizer industry however, P₂O₅ content larger than 30% is often required. Nonionic surfactants based on alkoxylated alcohols as secondary collector are commonly not able to achieve the desired selectivity.

U.S. Pat. No. 8,657,118 discloses a collector for the separation of phosphate by flotation of carbonates contained in non-sulfurous minerals, particularly phosphoric rock, preferably apatite. The collector comprises phosphoric ester.

WO 2016041916 discloses the use of branched fatty alcohol-based compounds selected from the group of fatty alcohols with 12-16 carbon atoms having a degree of branching of 1-3, and their alkoxylates with a degree of ethoxylation of up to 3, as secondary collector for the froth flotation of non-sulfidic ores in combination with a primary collector selected from the group of amphoteric and anionic surface-active compounds. The use for reverse flotation is not disclosed.

EP 0270933 discloses the use of branched fatty alcohols and their alkoxylates. The described compositions in EP 0270933 are only suitable to achieve a grade of less than 31% which may cause problems because of high dosing.

WO 2017162563 discloses a secondary collector mixture containing at least one compound selected from the group of branched fatty alcohols with 12-16 carbon atoms having a degree of branching of 1-3.5 and their alkoxylates with a degree of ethoxylation of up to 4, and at least one compound selected from the group of alkoxylates of nonionic hydrocarbon compounds with a degree of ethoxylation of higher than 3 and carbohydrate-based surfactants. Only non-ionic surfactants as co-collectors are disclosed.

U.S. Pat. No. 4,789,466 discloses a process for separating non-sulfidic minerals from an ore by flotation in which the ore is contacted with a mixture of (a) at least one adduct of ethylene oxide and propylene oxide with a C₈-C₂₂ fatty alcohol and (b) at least one anionic, cationic or ampholytic surfactant. Only binary collector compositions are disclosed.

Our older application PCT/EP2018/060455 discloses a collector composition for beneficiation of phosphates from phosphate containing ores, their use in flotation processes and a method for beneficiation of phosphates using said collector composition, wherein a ternary mixture comprising oleic acid, iso-tridecanol ethoxylated with 3 EO and iso-tridecanol ethoxylated with 10 EO is disclosed. Further, a ternary mixture comprising oleic acid, iso-tridecanol ethoxylated with 3 EO and dioctyl sulfosuccinate is disclosed.

### SUMMARY OF THE INVENTION

In the light of the prior art the technical problem underlying the present invention was the provision of collector compositions that overcome the disadvantages of those compositions known in the art. The collector compositions of the present invention are at least binary or ternary compositions that are suitable for direct and/or reverse flotation processes, show increased selectivity, offer the possibility of dose reduction and can be used for beneficiation of phosphate from phosphate containing ores. The process for flotation enables short process times and overcomes the disadvantages known in the art.

The problem is solved by the features of the independent claims. Preferred embodiments of the present invention are provided by the dependent claims.

The invention therefore relates to a collector composition for beneficiation of phosphates from phosphate containing ores comprising
I. at least one component A,
II. at least one component B, and
III. at least one component C,
   wherein the component A comprises unsaturated fatty acids having 12 to 22 carbon atoms, wherein the component B comprises alkoxylated branched alcohols as non-ionic surfactants which comprise two different types of alkoxy moieties, and wherein the component C comprises sulfur-containing surfactants.

In a preferred embodiment the component A is selected from the group consisting of a fatty acid blend with ≥90% C₁₆ to C₁₈ fatty acids with an unsaturation degree of 0.5 to 3, oleic acid, soy-bean fatty acids, tall oil, rosins, fatty acid peptides of the formula Cₙ₋₁H₂ₙ₋₁CO—NH—R with R being a residue of natural or artificial amino acids comprising glycine, sarcosine or taurine.

In a preferred embodiment the component B is an alkoxylated alcohol of the formula

R¹—O—(CH₂—CH(R²)—O)ₖ—(CH₂—CH(R³)—O)ₗ—(CH₂—CH(R⁴)—O)ₘ—R⁵,

wherein

R¹: is a branched alkyl group having 9 to 18 carbon atoms,

R²: is independently hydrogen or a hydrocarbyl group having 1 to 10 carbon atoms,

R³: is independently hydrogen or a hydrocarbyl group having 1 to 10 carbon atoms,

R⁴: is independently hydrogen or a hydrocarbyl group having 1 to 10 carbon atoms,

R⁵: is H or methyl

k: is an integer of 1 to 10,

l: is an integer of 1 to 10,

m: is an integer of 1 to 10, and

wherein R² and R³ or R³ and R⁴ are different.

In a preferred embodiment the alkoxylated branched alcohols of component B are ethoxylated and propoxylated branched alcohols which comprise alcohols having 9 to 18 carbon atoms.

In a preferred embodiment the component C is selected from the group consisting of sulfonated fatty acids, dialkyl sulfosuccinates, di- or tetraalkyl sulfosuccinamates, sodium dodecyl sulfate, dioctyl sulfosuccinate, alkyl ether sulfates, alkyl benzenesulfonates, alkyl sulfates of the formula CₙH₂ₙ₊₁OSO₃— with n=12 to 22.

In a preferred embodiment component B has a degree of ethoxylation in the range of 2 to 10 and a degree of propoxylation in the range of 1 to 10.

In a preferred embodiment the degree of branching of the alkoxylated branched alcohols of component B is in average in the range of 1 to 5.

A further aspect of the invention relates to the use the of collector composition for beneficiation of phosphates from phosphate containing ores wherein the collector composition comprises
I. at least one component A,
II. Let least one component B, and
III. at least one component C,
   wherein the component A comprises unsaturated fatty acids having 12 to 22 carbon atoms, wherein the component B comprises alkoxylated branched alcohols as non-ionic surfactants which comprise two different types of alkoxy moieties, and wherein the component C comprises sulfur-containing surfactants.

In a preferred embodiment the collector composition is used for direct flotation of phosphates by collecting phosphate in the froth.

In a preferred embodiment the collector composition is used for reverse flotation of phosphates by collection of impurities from phosphate containing ores in the froth.

In a preferred embodiment the collector composition is used for beneficiation of phosphates by flotation from sedimentary phosphate containing ores and/or from igneous phosphate containing ores.

The invention further relates to a flotation process for beneficiation of phosphates from phosphate containing ores comprising the collector composition of the present invention.

In a preferred embodiment the flotation process according to the present invention is a direct flotation process of phosphates, comprising the steps
Comminution of ores,
pH adjustment,
Optionally, conditioning of ores with depressants and/or activators,
Collector addition,
Flotation,
Collection of phosphate in the froth.

In a preferred embodiment the flotation process according to the present invention is a reverse flotation process of phosphates by collection of impurities from phosphate containing ores in the froth, comprising the steps
Comminution of ores,
pH adjustment,
Optionally, conditioning of ores with depressants and/or activators,
Collector addition,
Flotation,
Collection of carbonate and/or other impurities in the froth,
Recovering of phosphates from the cell product.

In a preferred embodiment in the flotation process according to the present invention the phosphate containing ores are pretreated to remove silicates.

In a preferred embodiment in the flotation process according to the present invention one or more modifiers and/or one or more frothers and/or one or more depressants are used.

### DETAILED DESCRIPTION OF THE INVENTION

The invention therefore relates to a collector composition for beneficiation of phosphates from phosphate containing ores comprising
I. at least one component A,
II. at least one component B, and
III. at least one component C,
   wherein the component A comprises unsaturated fatty acids having 12 to 22 carbon atoms, wherein the component B comprises alkoxylated branched alcohols as non-ionic surfactants which comprise two different types of alkoxy moieties, and wherein the component C comprises sulfur-containing surfactants. The component A in particular falls under the term “primary collector”, the component B and/or C in particular falls under the term “secondary collector”. The term “different types of alkoxy moieties” preferably means that the alkoxy group of the alkoxylated branched alcohols comprises for example an ethoxylated moiety and a propoxylated moiety. Moiety particularly has the similar meaning as group or unit.

Surprisingly, it was found that branched alcohol moieties with a branching degree of at least 1 and which are ethoxylated and propoxylated are significantly more suitable to achieve high selectivity and/or high recovery in froth flotation for beneficiation of phosphates when used as surfactant in combination with fatty acids and as a blend with sulfur containing emulsifiers. The use of such blends allows a significant increase in flotation selectivity, allowing concentrates with more than 30 wt % P₂O₅, for example 31-33 wt % P₂O₅ to be achieved without additional loss of apatite into the flotation slurry compared to the state of the art.

A further advantage of the present invention is that for example the use of a combination of two different components B and C in reverse phosphate flotation makes phosphate containing sedimentary ores accessible to phosphate beneficiation processes, in particular, when using a component B with two different types of alkoxy units in the alkoxylated branched alcohols. Particularly, the alkoxylated branched alcohols are for example ethoxylated and propoxylated, the alcohol moiety is branched, and the component C is a sulfur containing surfactant, in particular sodium docusate. Furthermore, it is an advantage that a ternary collector composition comprising at least the components A, B and C can efficiently be used for direct and/or reverse flotation of phosphate containing ores in order to increase the flotation selectivity and/or recovery. Surprisingly, the combination of one non-ionic surfactant (component B) and one anionic surfactant (component C) as collectors is suitable for direct and/or reverse flotation and improves the flotation performance with regard to improved grades and/or recoveries of P₂O₅.

As used herein, the term “phosphoric rock” or “phosphoric ore” relates to the ore sources, which in particular comprises phosphates. Phosphates are the desired or valuable material or mineral, which can be part of sedimentary phosphate deposits or igneous phosphate deposits. “Phosphate rock” or “phosphoric ore” falls under the general term of “non-sulfidic ores”.

As used herein, the term “impurities” relates to undesired material or mineral as component in phosphoric rock. The undesired material is also named gangue or waste. Impurities may comprise for example carbonates (e.g. calcite, dolomite), silicates, and/or scheelite. Impurities can also comprise silicate minerals such as quartz, feldspar or syenite minerals, layered silicates (micas, clays) or organic materials. The typical composition of phosphates preferably comprises different subtypes of apatite structure, such as for example fluoroapatite, hydroxoapatite, carbonatoapatite, chloroapatite or their combinations, also known as frankolyte.

As used herein, the term “flotation” relates to the separation of minerals based on differences in their hydrophobicity and their different ability to adhere or attach to air bubbles. Aim of flotation as mineral processing operation is to selectively separate certain materials. In particular, the flotation is used for beneficiation of phosphates from phosphate containing ores. Flotation comprises froth flotation methods like for example direct flotation or reverse flotation. Direct flotation of phosphates refers to methods where in particular phosphates are collected in the froth and the impurities remain in the slurry. Reverse flotation or inverse flotation of phosphates relates to methods where the impurities as undesired materials are collected in the froth and the phosphates remain in the slurry as cell product. In particular, reverse flotation of phosphates is similar to direct flotation of carbonates. Cell product has the similar meaning as cell underflow or slurry and means the product remaining in the cell in particular in reverse flotation processes. Froth product means the product obtained in the froth in particular in direct flotation processes. The term “concentrate” has the meaning of flotation product and refers to the material obtained as cell product (valuable material) in reverse flotation processes as well as to froth product as the material obtained in the froth (valuable material) in direct flotation processes. The term tailings or flotation tailings is understood economically and means the undesired product, impurities which are removed in direct or reverse flotation processes.

As used herein, the term “collector” relates to substances with the ability to adsorb to an ore particle and to make the ore particle hydrophobic in order to enable that the ore particles can attach to air bubbles during flotation. The collector may comprise for example at least one or two or three different collectors. A collector composition may comprise collector components which are named for example primary, secondary, ternary collector and can influence the collector composition properties. A collector composition comprises in particular mixtures of fatty acids and surfactants. The collectors can in particular be surface active, can have emulsification properties, can act as wetting agent, can be a solubility enhancer and/or a foam or froth regulator.

As used herein, the term “grade” relates to the content of the desired mineral or valuable or targeted material in the obtained concentrate after the enrichment via flotation. In particular, grade is the concentration of P₂O₅ obtained by the phosphate flotation process. The grade in particular refers to the P₂O₅ concentration and describes the content of P₂O₅ in the concentrate (w/w), particularly in the froth product at direct phosphate flotation and the content of P₂O₅ in the cell product in reverse phosphate flotation.

As used herein, the term “recovery” refers to the percentage of valuable material recovered after the enrichment via flotation. The relationship of grade (concentration) vs. recovery (amount) is a measure for the selectivity of froth flotation. The selectivity increases with increasing values for grade and/or recovery. With the selectivity the effectiveness/performance of the froth flotation can be described.

Preferably, the component A comprises fatty acids or derivatives thereof, for example saturated or unsaturated fatty acids with at least 12 carbon atoms. Preferably the fatty acids or derivatives thereof comprise 12 to 22 carbon atoms, more preferably 14 to 20 carbon atoms and most preferably 16 to 18 carbon atoms. Also preferred is a component A which comprises a fatty acid blend of 12 to 22 carbon atoms with more than 50% C₁₂ fatty acids. Further preferred is that component A comprises a fatty acid blend with 90% or more C₁₆ to C₁₈ fatty acids and with an average unsaturation degree of 0.5 to 3. The meaning of for example “fatty acids with 12 to 22 carbon atoms” is similar to the meaning of for example “C12 to C22 fatty acids”. It is preferred, that the component A is a natural product from plant or vegetable source or from animal source. The main source of component A besides palm oil and vegetable oils are tallow (animal) and tall oil (wood pulp side product). In particular, component A is a blend or mixture of fatty acids. The component A for example can contain different side products. Such side products may have an influence on the performance of the component A as collector in froth-flotation of non-sulfidic ores in particular during direct and/or reverse flotation of phosphates from phosphate containing ores. Oleic acid or a blend comprising oleic acid is a preferred substance for component A. Particularly preferred are also tall oil fatty acids (TOFA). Tall oil can be obtained as wood pulp side product. Tall oil comprises for example a fatty acid blend of oleic acid, linoleic acid, conjugated linoleic acid, stearic acid and for example other fatty acids and/or other components. Component A, in particular TOFA, can comprises resins in addition to the fatty acids or the fatty acid blend. Component A can also comprise fatty acid ester or fatty acid peptides. Component A can influence the hydrophobicity of foams in froth flotation for beneficiation of phosphates from phosphate containing ores. Component A in particular acts as primary collector in froth flotation processes. Further preferred as component A are fatty acid blends derived from, for example, soybean oil or rapeseed oil as vegetable oils. In particular, component A with an amount of about 70% or more of C22 fatty acids is preferred, which for example may derive from rapeseed oil.

It is preferred, that the component B in particular comprises non-ionic surfactants, which are alkoxylated branched alcohols which comprise in particular two different types of alkoxy groups/moieties. Preferably, the branched alkoxylated alcohols comprise ethoxylated and propoxylated moieties. Isotridecanol grades are preferred as alcohol moiety of component B. In particular, the component B can be used as secondary collector in froth flotation of non-sulfidic ores, in particular phosphoric ores. Further preferred is that the component B is in particular a non-ionic surfactant or a mixture thereof. It is further preferred that component B is a blend of non-ionic surfactants. Component B for example can be described as at least one adduct of two different types of alkoxy moieties with a C₈ to C₂₂ fatty alcohol. Preferably, component B is an adduct of ethylene oxide and propylene oxide with a C₈ to C₂₂ fatty alcohol. Further preferred is that the two different types of alkoxy moieties are selected from the group consisting of ethylene oxide, propylene oxide, butylene oxide, pentylene oxide, hexylene oxide, heptylene oxide, octylene oxide, nonylene oxide or decylene oxide.

In particular, component B is an alkoxylated alcohol of the formula

R¹—O—(CH₂—CH(R²)—O)ₖ—(CH₂—CH(R³)—O)ₗ—(CH₂—CH(R⁴)—O)ₘ—R⁵,

wherein

R¹: is a branched alkyl group having 9 to 18 carbon atoms,

R²: is independently hydrogen or a hydrocarbyl group having 1 to 10 carbon atoms,

R³: is independently hydrogen or a hydrocarbyl group having 1 to 10 carbon atoms,

R⁴: is independently hydrogen or a hydrocarbyl group having 1 to 10 carbon atoms,

R⁵: is H or methyl

k: is an integer of 1 to 10,

l: is an integer of 1 to 10,

m: is an integer of 1 to 10, and

wherein R² and R³ or R³ and R⁴ are different.

In component B the average number of alkoxy groups arises from the sum of all alkoxy groups of the individual molecules divided by the number of individual molecules. In particular, “degree of alkoxylation” in component B means the average molar ratio between the molecule which gets alkoxylated (reaction with oxiran or alkyloxirans), and the selected respective (alkyl)oxirans.

Preferably, the collector composition according to the present invention comprises a component B which comprises the alkoxylation product of branched alcohols, where the alcohols have 9 to 18, preferably 10 to 17, more preferably 11 to 15 and most preferably 12 to 14 carbon atoms. It is in particular preferred that the alkoxylated alcohols have 13 carbon atoms. The component B of the collector composition can comprise only one of such alcohols, but in particular comprises a mixture of such alcohols.

It is preferred if the alcohol mixture of component B has an average degree of branching from 1 to 5, preferably from 1.5 to 4.5, more preferably from 2 to 4 and most preferably from 2.5 to 3.5. It is in particular preferred that the degree of branching is about 3.

Preferably, the degree of alkoxylation of the alcohols for the component B in the collector composition according to the present invention assumes, on average, values in the range from 1 to 30, preferably from 2 to 25, more preferably from 3 to 20, even more preferred from 5 to 15. As degree of alkoxylation of the alcohols for the component B any value between these values or ranges thereof are also preferred. It is in particular preferred that the degree of alkoxylation of the alcohols for the component B is about 5, 6, 7, 8, 9, 10, 11, 12, 13, 14, 15.

Preferably, the alkoxy units of the branched alcohols in component B are C₁-C₁₀-alkoxy groups, preferably ethoxy, propoxy, butoxy, pentoxy, hexoxy, heptoxy, octoxy, nonoxy and/or decoxy groups. Ethoxy, propoxy and butoxy groups are more preferred. It is in particular preferred that the alkoxy groups of the branched alcohols in component B are ethoxy and propoxy groups. It is possible for the alkoxylation to take place in random distribution or blockwise, meaning that the aforementioned alkoxy groups—whether these are different—occur blockwise. Preferably, the end-groups of the EO-PO-chains are not capped with alkyl-groups. Preferably, the end-groups of the EO-PO-chains have free —OH groups.

Preferably, the degree of ethoxylation of the alcohols for the component B in the collector composition according to the present invention assumes, on average, values in the range from 2 to 10, preferably from 3 to 8, more preferably from 4 to 7. It is particularly preferred that the degree of ethoxylation of the alcohols for the component B is about 4, 5, 6, 7, 8, 9, 10 or any value between these values or ranges thereof.

Preferably, the degree of propoxylation of the alcohols for the component B in the collector composition according to the present invention assumes, on average, values in the range from 1 to 10, preferably from 2 to 7, more preferably from 2 to 5. It is in particularly preferred that the degree of propoxylation of the alcohols for the component B is about 1, 2, 3, 4, 5, 6 or any value between these values or ranges thereof.

It is preferred, that the component C can act as secondary and/or ternary collector in froth flotation of non-sulfidic ores, in particular phosphoric ore. Preferably, component C comprises sulfonated fatty acids, dialkyl sulfosuccinates, di- or tetraalkyl sulfosuccinamates, sodium dodecyl sulfate, alkyl ether sulfates, alkyl benzenesulfonates, di(2-ethylhexyl)sulfosuccinate. Dioctyl sulfosuccinate is a preferred component C. Also preferred as component C, are for example sulfonates or sulfates like dodecylbenzene sulfonic acid or salts thereof, sodium lauryl sulfate, sodium laureth sulfate, sodium coco sulfate, alkyl sulfates, alkyl sulfonates, petroleum sulfonates.

It is preferred, that the collector composition of the present invention comprises at least two different types of secondary collectors. Preferably the difference between component B and component C is that one component is non-ionic and the other component is ionic.

Furthermore, the collector composition can have alkoxylation products, in which case alcohols do not have the number of carbon atoms stated above from these products. These are in particular alcohols having 1 to 7 carbon atoms, and also alcohols with more than 12 carbon atoms. However, it is preferred if this group of compounds has a weight fraction of at most 10% by weight, preferably of less than 5% by weight, based on the total weight of the collector composition. Furthermore, unreacted alcohols may be present in the collector composition.

If two or more alcohols are used for the component B, in the event that the alcohol has 10 carbon atoms, it is preferred that this mixture is a C10 Guerbet alcohol mixture. Here, the main components are 2-propylheptanol and 5 methyl-2-propylhexanol. For example, the component B may consist to at least 90%, preferably 95%, of such mixture.

Further preferred is that during the flotation process a modifier is added in addition to the collector composition of the present invention. Such modifier can be for example a pH-modifier. PH-modifier comprise for example lime, soda ash, caustic soda, sulfuric acid, hydrochloric acid, phosphoric acid. It is further preferred that for example depressants, activators and/or frothers are used during the flotation process for conditioning the ores as far as necessary.

Preferably, the amount of component A in weight-% (wt %) in relation to the total collector composition is in the range from 50 wt % to 90 wt %, preferably in the range from 55 wt % to 85 wt %, more preferably in the range from 60 wt % to 80 wt % and most preferably in the range from 65 wt % to 75 wt %. It is particularly preferred that the amount of component A in weight-% in relation to the total collector composition is about 70 wt %. Further preferred amount of component A are about 66 wt %, 67 wt %, 68 wt %, 69 wt %, 70 wt %, 71 wt %, 72 wt %, 73 wt %, 74 wt % or any value between these values or ranges thereof.

Preferably, the amount of component B in weight-% (wt %) in relation to the total collector composition is in the range from 1 wt % to 49 wt %, preferably in the range from 5 wt % to 40 wt %, more preferably in the range from 10 wt % to 30 wt % and most preferably in the range from 10 wt % to 20 wt %. It is particularly preferred that the amount of component B in weight-% in relation to the total collector composition is about 15 wt %. Further preferred amounts of component B are about 10 wt %, 11 wt %, 12 wt %, 13 wt %, 14 wt %, 15 wt %, 16 wt %, 17 wt %, 18 wt %, 19 wt %, 20 wt % or any value between these values or ranges thereof.

Preferably, the amount of component C in weight-% (wt %) in relation to the total collector composition is in the range from 1 wt % to 49 wt %, preferably in the range from 5 wt % to 40 wt %, more preferably in the range from 10 wt % to 30 wt % and most preferably in the range from 10 wt % to 20 wt %. It is particularly preferred that the amount of component C in weight-% in relation to the total collector composition is about 15 wt %. Further preferred amounts of component C are about 10 wt %, 11 wt %, 12 wt %, 13 wt %, 14 wt %, 15 wt %, 16 wt %, 17 wt %, 18 wt %, 19 wt %, 20 wt % or any value between these values or ranges thereof.

Preferably, the amount of further additives and/or modifier is in the range from 0% to 10%, preferably in the range from 0.2% to 8%, more preferably in the range from 0.4% to 6% and most preferably in the range from 0.5% to 5%.

A further aspect is the use of a collector composition for beneficiation of phosphates from phosphate containing ores, wherein the collector composition comprises

I. at least one component A,

II. at least one component B, and

III. at least one component C,

wherein the component A comprises unsaturated fatty acids having 12 to 22 carbon atoms, wherein the component B is an alkoxylated branched alcohol as non-ionic surfactant which comprises two different types of alkoxy moieties, wherein the component C is a sulfur-containing surfactant.

It is in particular preferred that the collector composition of the present invention is used in form of a “ready to use” composition. This means that a mixture of the component A, component B and component C can be prepared and optionally stored, before the collector composition is used in a flotation process. This could also mean that a mixture of the component B and component C can be prepared and optionally stored as “ready to use” composition, before the collector composition is used in a flotation process. Such mixture can be named “pre-mixture” and can act for example as self-emulsifying composition when the collector composition (pre-mixture) is added to an ore-slurry before start of the flotation. Further preferred is also that the individual components A, B and C are added separately or in a dual combination e.g. as binary “ready to use” mixture or composition to an ore-slurry before flotation starts.

Preferably the collector composition is used for direct flotation of phosphates by collecting phosphate in the froth. It is further preferred, that the collector composition is used for reverse flotation of phosphates by collection of impurities from phosphate containing ores in the froth. Also preferred is that the collector composition is used for flotation of phosphates from sedimentary phosphate containing ores and/or from igneous phosphate containing ores. Concentrates produced by flotation from sedimentary ores for examples comprise <1% MgO, >30% P₂O₅, <4% SiO₂. Concentrates produced by flotation from igneous ores for example comprise <1% MgO, >35% P₂O₅, <2% SiO₂. Preferably, sedimentary phosphate containing ores are processed by direct flotation or by reverse flotation using for example the collector composition of the present invention. It is preferred, that igneous phosphate containing ores are for example processed by direct flotation using in particular the collector composition of the present invention.

Preferably the collector composition of this invention is used in the mining industry for mineral processing by in particular froth flotation processes for separating desired minerals from gangue and impurities. It is an advantage that by using the collector composition according to the present invention differences in hydrophobicity between desired (valuable) mineral, in particular phosphates, and impurities (waste, gangue), in particular carbonates, are increased. When using the collector composition of the present invention, a selective separation of in particular the minerals phosphates and carbonates is possible. The present collector composition makes complex ore mixtures comprising for example phosphates, silicates, carbonates and optionally other impurities accessible for beneficiation of phosphate. By using the collector composition of the present invention, processing of complex ores, which contain impurities or undesired ores, for example carbonates in phosphate ores, becomes economically feasible. It is possible to use the collector composition in flotation processes for the separation of large ranges of carbonates and silicates prior to further refinement. The collector composition can in particular be used to upgrade (purify) phosphates by flotation technology, in particular by froth flotation processes. With the use of the present collector composition, complex processes can be avoided and the enrichment of phosphate for subsequent use in fertilizers is possible. The collector composition can in particular be used for phosphate containing ores which were up to now not suitable for the beneficiation of phosphates.

In a further aspect the invention relates to a flotation process for beneficiation of phosphate from phosphate containing ores comprising the collector composition of the present invention. As pretreatment of the ores before direct flotation and/or reverse flotation the ores may be crushed or ground to finer particles. For the froth flotation then the targeted mineral, in particular phosphates in case of direct flotation and in particular carbonates and/or silicates or other impurities in case of reverse flotation, is rendered hydrophobic by addition of the collector composition. The targeted minerals can either be collected in the froth (direct flotation) or remain in the slurry as cell product (reverse flotation). Flotation can be undertaken in several stages/cycles to maximize the recovery of the desired mineral and to maximize the concentration of the desired mineral. Surprisingly, by addition of the collector composition of the present invention the number of stages/cycles can be reduce while achieving the same grade as with more stages/cycles.

It must be noted that as used herein, the singular forms “a”, “an”, and “the”, include plural references unless the context clearly indicates otherwise. Thus, for example, reference to “a reagent ” includes one or more of such different reagents and reference to “the method” includes reference to equivalent steps and methods know to those of ordinary skill in the art that could be modified or substituted for the methods described herein.

Unless otherwise indicated, the term “at least” preceding a series of elements is to be understood to refer to every element in the series. Those skilled in the art will recognize or be able to ascertain using no more than routine experimentation, many equivalents to the specific embodiments of the invention described herein. Such equivalents are intended to be encompassed by the present invention.

The term “and/or” wherever used herein includes the meaning of “and”, “or” and “all or any other combination of the elements connected by said term”.

The term “about” or “approximately” as used herein means within 20%, preferable within 10%, and more preferably within 5% of a given value or range. The term “about” or “approximately” as used herein also includes the exact respective values or ranges.

Throughout the specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integer or step. When used herein the term “comprising” can be substituted with the term “containing” or “including” or sometimes when used herein with the term “having”.

When used herein “consisting of” excludes any element, step, or ingredient not specified in the claim element. When used herein, “consisting essentially of” does not exclude material or steps that do not materially affect the basic and novel characteristics of the claim.

Although the invention has been described with respect to specific embodiments and examples, it should be appreciated that other embodiments utilizing the concept of the present invention are possible without departing from the scope of the invention. The present invention is defined by the claimed elements, and any and all modifications, variations, or equivalents that fall within the true spirit and scope of the underlying principles.

Preferred is the following set of clauses 1 to 15:

1. Collector composition for beneficiation of phosphates from phosphate containing ores comprising
I. at least one component A,
II. at least one component B, and
III. at least one component C,
   wherein the component A consists of unsaturated fatty acids having 12 to 22 carbon atoms, wherein the component B consists of alkoxylated branched alcohols as non-ionic surfactant which comprise two different types of alkoxy moieties, and wherein the component C consists of sulfur-containing surfactants,
   wherein the amount of component A in weight-% in relation to the total collector composition is in the range from 50 wt % to 90 wt %,
   wherein the amount of component B in weight-% in relation to the total collector composition is in the range from 1 wt % to 49 wt %,
   wherein the amount of component C in weight-% in relation to the total collector composition is in the range from 1 wt % to 49 wt %.

2. Collector composition according to clause 1, wherein the component A is selected from the group consisting of a fatty acid blend with ≥90% C16 to C18 fatty acids with an unsaturation degree of 0.5 to 3, oleic acid or soybean fatty acids.

3. Collector composition according to clause 1 or 2, wherein the alkoxylated branched alcohols of component B are ethoxylated and propoxylated branched alcohols which comprise alcohols having 9 to 18 carbon atoms.

4. Collector composition according to any one of clauses 1 to 3, wherein the component C is selected from the group consisting of sulfonated fatty acids, dialkyl sulfosuccinates, di- or tetraalkyl sulfosuccinamates, sodium dodecyl sulfate, dioctyl sulfosuccinate, alkyl ether sulfates, alkyl benzenesulfonates, alkyl sulfates of the formula CnH2n+1OSO3- with n=12 to 22.

5. Collector composition according to any one of the preceding clauses, wherein the degree of ethoxylation of component B is in the range of 2 to 10 and the degree of propoxylation of component B is in the range of 1 to 10.

6. Collector composition according to anyone of the preceding clauses, wherein the degree of branching of the alkoxylated branched alcohols of component B is in average in the range of 1 to 5.

7. Use of collector composition for beneficiation of phosphates from phosphate containing ores wherein the collector composition comprises

I. at least one component A,

II. at least one component B, and

III. at least one component C,

wherein the component A consists of unsaturated fatty acids having 12 to 22 carbon atoms, wherein the component B consists of alkoxylated branched alkohols as non-ionic surfactants which comprise two different types of alkoxy moieties, and wherein the component C consists of sulfur-containing surfactants,
wherein the amount of component A in weight-% in relation to the total collector composition is in the range from 50 wt % to 90 wt %,
wherein the amount of component B in weight-% in relation to the total collector composition is in the range from 1 wt % to 49 wt %,
wherein the amount of component C in weight-% in relation to the total collector composition is in the range from 1 wt % to 49 wt %.

8. Use of collector composition according to clause 7 for direct flotation of phosphates by collecting phosphate in the froth.

9. Use of collector composition according to clause 7 for reverse flotation of phosphates by collection of impurities from phosphate containing ores in the froth.

10. Use of collector composition according to any one of clauses 7 to 9 for beneficiation of phosphates by flotation from sedimentary phosphate containing ores and/or from igneous phosphate containing ores.

11. Flotation process for beneficiation of phosphates from phosphate containing ores comprising the collector composition according to anyone of clauses 1 to 6.

12. Flotation process according to clause 11 for direct flotation of phosphates, comprising the steps
Comminution of ores,
pH adjustment,
Optionally, conditioning of ores with depressants and/or activators,
Collector addition,
Flotation,
Collection of phosphate in the froth.

13. Flotation process according to clause 11 for reverse flotation of phosphates by collection of impurities from phosphate containing ores in the froth, comprising the steps
Comminution of ores,
pH adjustment,
Optionally, conditioning of ores with depressants and/or activators,
Collector addition,
Flotation,
Collection of carbonate and/or other impurities in the froth,
Recovering of phosphates from the cell product.

14. Flotation process according to anyone of clauses 11 to 13, wherein the phosphate containing ores are pretreated to remove silicates.

15. Flotation process according to anyone of clauses 11 to 14, wherein one or more modifiers and/or one or more frothers and/or one or more depressants are used.

### EXAMPLES

The invention is further described by the following examples. The examples relate to practical and in some cases preferred embodiments of the invention that do not limit the scope of the invention.

### Example 1

### Reverse Flotation (Collection of Carbonate Impurities in the Froth)

### Methodology

A sample of calcareous phosphate ore with 20.2% P₂O₅ was ground in a rod mill to d80˜150 μm. 240 g ore was placed in a 1.5 L flotation cell in a Denver D12 flotation machine and slurried up with 1.25 L tap water. 2.5 kg/t H₃PO₄ was added as 20% aqueous solution (w/w), after which the pH of the slurry was reduced to 5 by addition of 10% (w/w) sulfuric acid solution. The pH was maintained between 4.5 and 5.5 throughout the experiment.

The slurry was conditioned with 400 g/t collector consisting of 70% oleic acid, 15% component A and 15% component B for 1 minute and then subjected to a single flotation stage for 2 minutes. Froth (tailings) and cell product (concentrate) were analyzed for P₂O₅ content. The results in terms of P₂O₅ concentrate grade are listed in Table 1.

TABLE 1

| | comparative | inventive |
|---|---|---|
| Component A | Oleic acid 70% | Oleic acid 70% |
| | Vegetable source | Vegetable source |
| Component B | ethoxylated | alkoxylated |
| | Isotridecanol | Isotridecanol |
| | (3EO) 15% | (6-7 EO, 3-4 |
| | | PO)15% |
| Component C | Dioctyl | Dioctyl |
| | sulfosuccinate | sulfosuccinate |
| | (75% aqueous | (75% aqueous |
| | solution) 15% | solution) 15% |
| Dosage [g/t] | 400 | 400 |
| Grade [wt % P₂O₅] | 29.7 | 32.5 |

From table 1 it becomes obvious that with the collector composition which comprises the described components A, B and C the grade of P₂O₅ can be increased to values above 31 wt %. This is unexpected in comparison to the collector composition which comprises as component B just an ethoxylated branched isotridecanol surfactant (CAS-No. 69011-36-5) in comparison to the inventive example with an ethoxylated and propoxylated branched isotridecanol surfactant. Consequently, the ternary collector composition and in particular the inventive composition comprising the components B and C as secondary and/or ternary collector offer a synergistic effect with regard to P₂O₅ grade, which is desirous for subsequent processing to e.g. fertilizer. The oleic acid (CAS-No. 112-80-1) as component A is for example from vegetable source. The component B is an ethoxylated and propoxylated isotridecanol grade/mixture (CAS-No. 196823-11-7) with a degree of ethoxylation of about 6-7, with a degree of propoxylation of about 3-4. The Dioctyl sulfosuccinate (CAS-No. 577-11-7) as component C is used as an 75% aqueous solution.

### Example 2

### Direct Flotation (Collection of Phosphate in the Froth)

### Methodology

A weathered igneous phosphate ore containing 14% P₂O₅ was ground to d₈₀˜100 μm and deslimed to 20 μm using fractionated settling calculated using Stokes Law. 470 g deslimed feed was placed in a 2.5 L flotation cell in a Denver D12 flotation machine conditioned with 2 kg/t Na₂CO₃ and 300 g/t Na₂SiO₃, then with 600 g/t collector consisting of 70% plant based fatty acid (soybean fatty acid (CAS-No. 68308-53-2)) as component A, 15% component B and 15% component C. The flotation concentrate was subjected to 2 cleaner stages. The final results are summarized in Table 2.

TABLE 2

| | comparative | comparative | comparative | inventive |
|---|---|---|---|---|
| Component | Soybean fatty | Soybean fatty | Soybean fatty | Soybean fatty |
| A | acid 70% | acid 70% | acid 70% | acid 70% |
| Component | ethoxylated | ethoxylated | alkoxylated | alkoxylated |
| B | Isotridecanol | Isotridecanol | Isotridecanol | Isotridecanol |
| | (3EO) 15% | (3EO) 15% | (6-7 EO, 3-4 | (6-7 EO, 3-4 |
| | | | PO) 30% | PO) 15% |
| Component | ethoxylated | Dioctyl | — | Dioctyl |
| C | Isotridecanol | sulfosuccinate | | sulfosuccinate |
| | (10 EO) 15% | (75% aqueous | | (75% aqueous |
| | | solution) 15% | | solution) 15% |
| Dosage [g/t] | 600 | 600 | 600 | 600 |
| Grade [wt % | 40.6 | 39.4 | 38.1 | 39.3 |
| P₂O₅] | | | | |
| Recovery [% | 76.2 | 77.4 | 75.4 | 81.4 |
| P₂O₅] | | | | |

In Table 2 it can be seen that for direct flotation the results with a collector composition which is ternary and comprises as component B a mixture of ethoxylated and propoxylated isotridecanol grade leads to higher recovery values [% P₂O₅] in comparison to compositions with mixtures of just ethoxylated branched alcohols as component B (CAS-No. 69011-36-5) in combination with component C (ethoxylated isotridecanol (CAS-No. 69011-36-5) or dioctyl sulfosuccinate (CAS-No. 577-11-7)). Surprisingly, it was further observed that with the collector composition of the present invention comprising particularly two different types of surfactants (non-ionic and anionic) as secondary and/or ternary collector (mixture of ethoxylated and propoxylated branched isotridecanol (CAS-No. 196823-11-7) as component B and dioctyl sulfosuccinate (CAS-No. 577-11-7) as component C), phosphate containing ores are accessible for direct flotation of phosphates. It was unexpected that for example a mixture of inventive secondary/ternary collectors can be used for direct flotation and for reverse flotation of phosphates. This becomes obvious when comparing the results from table 1 and table 2, in which in both cases the similar component B and component C in a ternary collector composition is used. From Table 2 it becomes also obvious that surprisingly a ternary collector composition comprising the inventive components A, B and C (fatty acid, alkoxylated branched alcohol, sulfur containing surfactant) shows better recovery in comparison to a binary collector composition comprising just the components A and B.

### Example 3

### Direct Flotation (Collection of Phosphate in the Froth)

### Methodology

A phosphate bearing laterite containing 21% P₂O₅ was ground to d₈₀˜90 μm and deslimed to 20 μm using fractionated settling calculated using Stokes Law. 470 g deslimed feed was placed in a 2.5 L flotation cell in a Denver D12 flotation machine conditioned with 400 g/t NaOH and 300 g/t Na₂SiO₃, then with 500 g/t collector consisting of 70% (soybean fatty acid (CAS-No. 68308-53-2)), 15% component B and 15% component B. The flotation concentrate was subjected to 2 cleaner stages, followed by a magnetic separation to remove residual magnetite. The final results are summarized in table 3.

TABLE 3

| | comparative | comparative | inventive |
|---|---|---|---|
| Component A | Soybean fatty | Soybean fatty | Soybean fatty |
| | acid 70% | acid 70% | acid 70% |
| Component B | alkoxylated | — | alkoxylated |
| | Isotridecanol | | Isotridecanol |
| | (6-7 EO, 3-4 | | (6-7 EO, 3-4 |
| | PO) 30% | | PO) 15% |
| Component C | — | Dioctyl | Dioctyl |
| | | sulfosuccinate | sulfosuccinate |
| | | (75% aqueous | (75% aqueous |
| | | solution) | solution) |
| | | 30% | 15% |
| Dosage [g/t] | 500 | 500 | 500 |
| Grade [wt % P₂O₅] | 39.9 | 37.6 | 38.0 |
| Recovery [% P₂O₅] | 60.7 | 75.8 | 79.8 |

From table 3 it becomes obvious that unexpectedly, a ternary collector composition comprising the component A (soybean fatty acid (CAS-No. 68308-53-2)) and the component B (alkoxylated (ethoxylated and propoxylated) branched isotridecanol (CAS-No. 196823-11-7)) and the component C (dioctyl sulfosuccinate (CAS-No. 577-11-7)) show better recovery than a binary collector composition comprising in addition to soybean fatty acids (component A) either alkoxylated tridecanol (component B) or dioctyl sulfosuccinate (component C). Consequently, according to the present invention particularly the ternary collector composition comprising two different co-collectors, wherein alkoxylated branched alcohol as component B comprises two different types of alkoxy groups and wherein the component C comprises sulfur containing surfactants, are of advantage for the recovery of phosphate from phosphate containing ores via flotation.

1. A collector composition for beneficiation of phosphates from phosphate containing ores, comprising:
I. at least one component A,
II. at least one component B, and
III. at least one component C,
wherein the component A comprises an unsaturated fatty acid having 12 to 22 carbon atoms, wherein the component B comprises alkoxylated branched alcohols as non-ionic surfactant comprising two different types of alkoxy moieties, and wherein the component C comprises a sulfur-containing surfactant.

2. A collector composition according to claim 1, wherein the component A is selected from the group consisting of a fatty acid blend with >90% C- to Cis fatty acids with an unsaturation degree of 0.5 to 3, oleic acid, soybean fatty acids, tall oil, rosins, fatty acid peptides of the formula Cₙ-i H₂ₙ-iCO—NH—R with R being a residue of natural or artificial amino acids comprising glycine, sarcosine or taurine.

3. A collector composition according to claim 1, wherein the alkoxylated branched alcohols of component B are ethoxylated and propoxylated branched alcohols which comprise alcohols having 9 to 18 carbon atoms.

4. A collector composition according to claim 1, wherein the component C is selected from the group consisting of sulfonated fatty acids, dialkyl sulfosuccinates, di- or tetraalkyl sulfosuccinamates, sodium dodecyl sulfate, dioctyl sulfosuccinate, alkyl ether sulfates, alkyl benzenesulfonates, alkyl sulfates of the formula CₙH2ₙ₊ᵢ0S03 with n=12 to 22.

5. A collector composition according to claim 1, wherein the degree of ethoxylation of component B is in the range of 2 to 10 and the degree of propoxylation of component B is in the range of 1 to 10.

6. A collector composition according to claim 1, wherein the degree of branching of the alkoxylated branched alcohols of component B is in average in the range of 1 to 5.

7. A method of using a collector composition for beneficiation of phosphates from phosphate containing ores, wherein the collector composition comprises:
I. at least one component A,
II. at least one component B, and
III. at least one component C, wherein the component A comprises unsaturated fatty acids having 12 to 22 carbon atoms, wherein the component B comprises alkoxylated branched alkohols as non-ionic surfactants which comprise two different types of alkoxy moieties, and wherein the component C comprises sulfur-containing surfactants.

8. The method of claim 7 for direct flotation of phosphates by collecting phosphate in a froth.

9. The method of claim 7 for reverse flotation of phosphates by collection of impurities from phosphate containing ores in a froth.

10. The method of claim 7 for beneficiation of phosphates by flotation from sedimentary phosphate containing ores, from igneous phosphate containing ores, or both.

11. A flotation process for beneficiation of phosphates from phosphate containing ores comprising the collector composition according to claim 1.

12. A flotation process according to claim 11 for direct flotation of phosphates, comprising:
comminution of the ores;
pH adjustment;
optionally, conditioning of the ores with depressants, activators, or both depressants and activators;
collector addition;
flotation to form a froth comprising phosphate; and
collection of the phosphate in the froth.

13. A flotation process according to claim 11 for reverse flotation of phosphates by collection of impurities from phosphate containing ores in the froth, comprising:
comminution of the ores;
pH adjustment;
optionally, conditioning of the ores with depressants, and/or activators or both depressants and activators;
collector addition;
flotation to form a froth comprising phosphate;
collection of carbonate alone or in combination with other impurities in the froth; and
recovering of the phosphate from the cell product.

14. A flotation process according to claim 11, wherein the phosphate containing ores are pretreated to remove silicates.

15. A flotation process according to claim 11, wherein (a) one or more modifiers, (b) one or more frothers, (c) one or more depressants, or (a), (b) and (c) are used.
